(19) United States
(12) Patent Application Publication
(10) Pub. No.: US 2012/0008257 A1
(43) Pub. Date: Jan. 12, 2012

(54) CELL TOWER WIRING JUNCTION BOX

(75) Inventors: Kenneth D. Rebers, Georgetown, TX (US); Robert W. Bunte, Georgetown, TX (US)

(73) Assignee: 3M Innovative Properties Company

(21) Appl. No.: 13/165,222

(22) Filed: Jun. 21, 2011

Related U.S. Application Data
(60) Provisional application No. 61/361,640, filed on Jul. 6, 2010.
(60) Provisional application No. 61/380,845, filed on Sep. 8, 2010.

(51) Int. Cl. H02B 1/26

(52) U.S. Cl. 361/622

(57) ABSTRACT

An enclosure for protecting transitioning cell tower cables comprises a base and a cover coupled to the base via a hinge. The base and the cover form an interior cavity when placed in a closed position. The enclosure further includes at least one entrance port formed in at least a portion of a front end of at least one of the base and the cover. The enclosure further includes a plurality of exit ports, wherein a first set of exit ports are formed in a first side wall of the enclosure and a second set of exit ports are formed in a second side wall of the enclosure. The entrance port(s) is/are configured to receive a first cable comprising multiple lines. The plurality of exit ports are each configured to receive at least one individual line from the multiple lines. In another aspect, one or more support plates are disposed in the interior cavity, where a plurality of strain relief brackets are mounted to the support plate(s) and are configured to clamp individual lines from the first cable to the one or more support plates.

### CROSS REFERENCE TO RELATED APPLICATIONS

This application claims the benefit of U.S. Provisional Patent Application No. 61/361,640, filed Jul. 6, 2010, and U.S. Provisional Patent Application No. 61/380,845, filed Sep. 8, 2010, the disclosures of which are incorporated by reference herein in their entirety.

### BACKGROUND OF THE INVENTION

1. Field of the Invention

The present invention relates to an enclosure to protect a wiring junction or transition point at a cell tower location.

2. Background

The continuing expansion of wireless communication and its accompanying wireless technology will require many more “cell sites” than currently deployed. This expansion has been estimated from a doubling to a ten-fold increase in the current number of cell sites, particularly in the deployment of 4G/LTE. This dramatic increase in the number of cell sites is due, in large part, to the high bandwidth demand for wireless applications and the bandwidth to the cell site must be shared to the available UE (user equipment) within range of the site.

Better wireless communication coverage is needed in order to get the bandwidth to the increasing number of customers that demand it. Thus, new deployments of traditional, large “macro” cell sites, which typically include large cell towers, are continuing. With that increased cell tower deployment, there is a need for additional accessories and components used to distribute cables and wiring on the cell towers.

### SUMMARY

The present invention is directed to an enclosure to protect a wiring junction or transition point at a cell tower location.

According to a first aspect of the invention, an enclosure (also referred to herein as a junction box) for protecting transitioning cell tower cables comprises a base and a cover coupled to the base via a hinge. The base and the cover form an interior cavity when placed in a closed position. The enclosure further includes at least one entrance port formed in at least a portion of a front end of at least one of the base and the cover. The enclosure further includes a plurality of exit ports, wherein a first set of exit ports are formed in a first side wall of the enclosure and a second set of exit ports are formed in a second side wall of the enclosure. The entrance port(s) is/are configured to receive a first cable comprising multiple lines. The plurality of exit ports are each configured to receive at least one individual line from the multiple lines. In another aspect, one or more support plates are disposed in the interior cavity, where a plurality of strain relief brackets are mounted to the support plate(s) and are configured to clamp individual lines from the first cable to the one or more support plates.

In another aspect, each exit port includes an end cap configured to receive at least one of the individual lines.

In another aspect, the first and second side walls are opposite one another.

In another aspect, the enclosure further comprises corrugated tubing received in the at least one entrance port, the corrugated tubing configured to accommodate the first cable.

In another aspect, the enclosure further comprises a cable clamp to clamp the first cable and corrugated tubing to a support plate.

In another aspect, the enclosure further comprises through-holes disposed in the one or more support plates to receive fasteners to secure the enclosure to a strut or frame of the cell tower.

In another aspect, at least one of the one or more support plates extends outside the enclosure. In a further aspect, the enclosure includes through-holes disposed in the one or more support plates outside the enclosure to receive fasteners to secure the enclosure to a strut or frame of the cell tower.

In another aspect, the enclosure further comprises one or more cable routing members formed on an inner surface of at least one of the cover and the base.

In another aspect, the enclosure comprises a double wall blow molded structure. In a further aspect, the enclosure has a length of about 18 to about 24 inches, a width of about 14 to about 17 inches, and a cavity depth of about 3 to about 5 inches.

In another aspect, the hinge comprises a living hinge.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A is an isometric view of an exemplary junction box according to a first aspect of the invention.

FIG. 1B is another isometric view of the exemplary junction box of FIG. 1A.

FIG. 1C is a top view of the exemplary junction box of FIG. 1A in an open position.

FIG. 1D is a close up view of the interior of the exemplary junction box of FIG. 1A.

FIG. 1E is another isometric view of the exemplary junction box of FIG. 1A in an open position.

FIG. 2 is an isometric view of an exemplary junction box according to another aspect of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to an enclosure, referred to herein as a junction box, that protects and secures the transition of cabling, such as fiber and/or electrical wiring, at a cell tower location. The junction box receives communication cabling, preferable cabling for providing signals to/from cell towers and distributes those cables to particular antenna locations at or near the top of a cell tower. The junction box provides strain relief and protection for the individual cables. The junction box as described herein is of straightforward construction, and uses comparatively few components to enable easy assembly in the field, even at difficult or inaccessible locations.

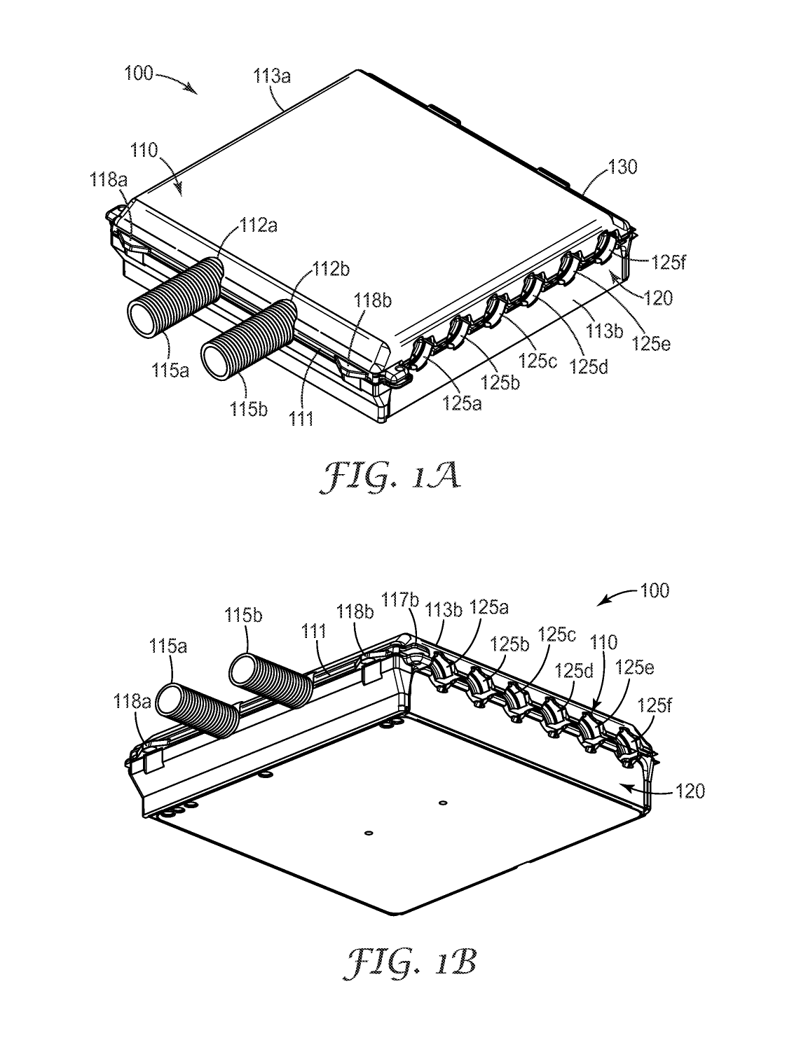

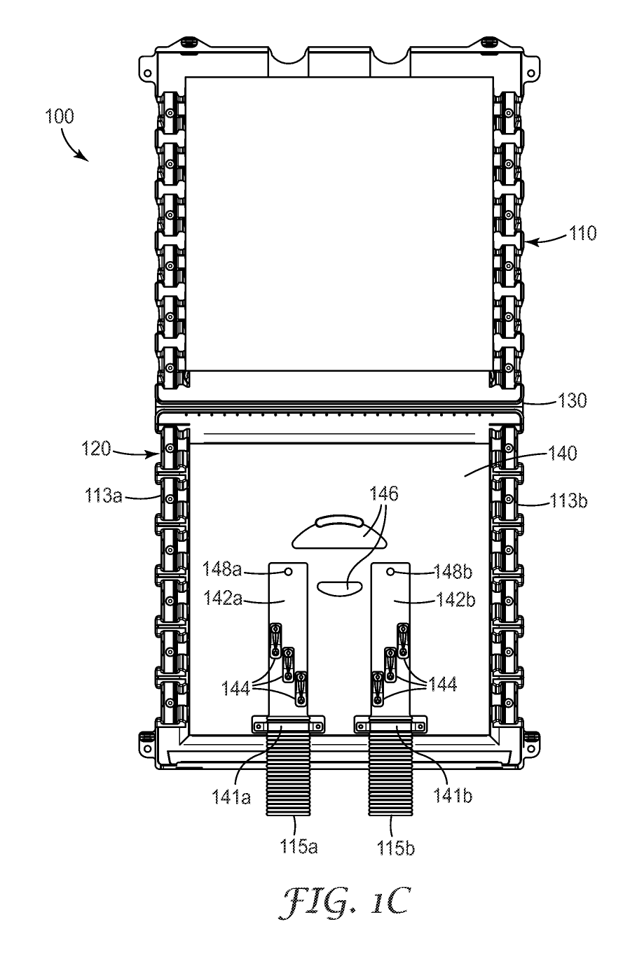

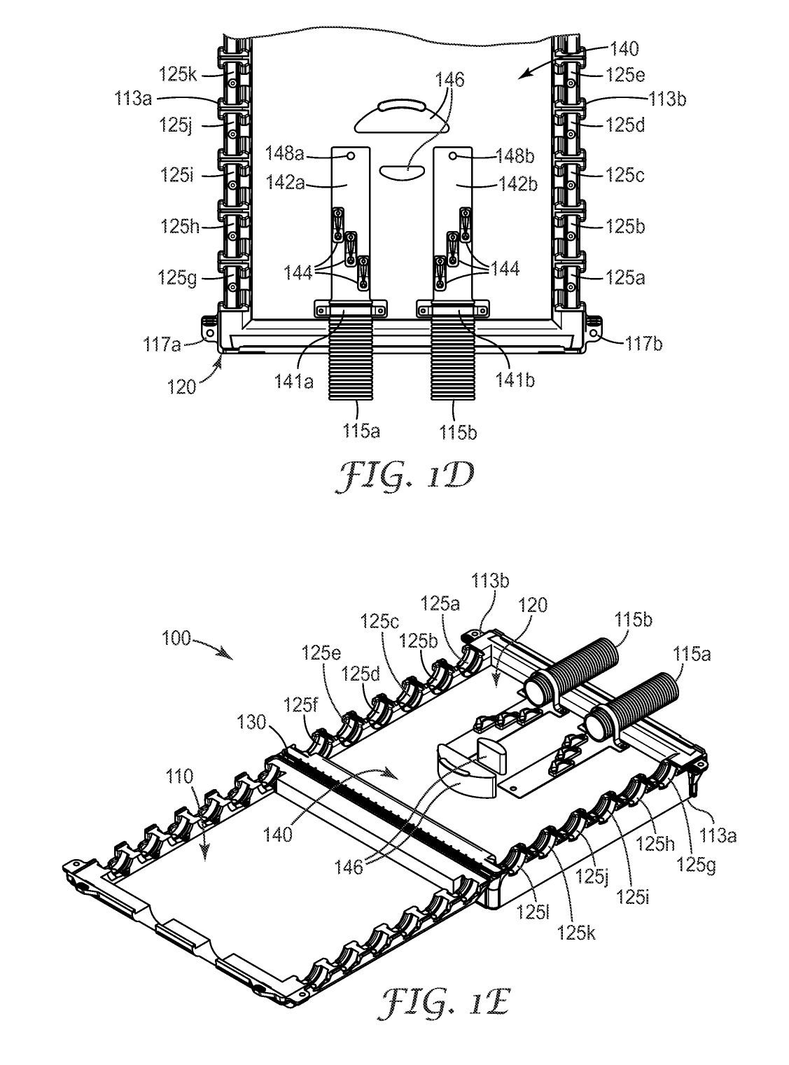

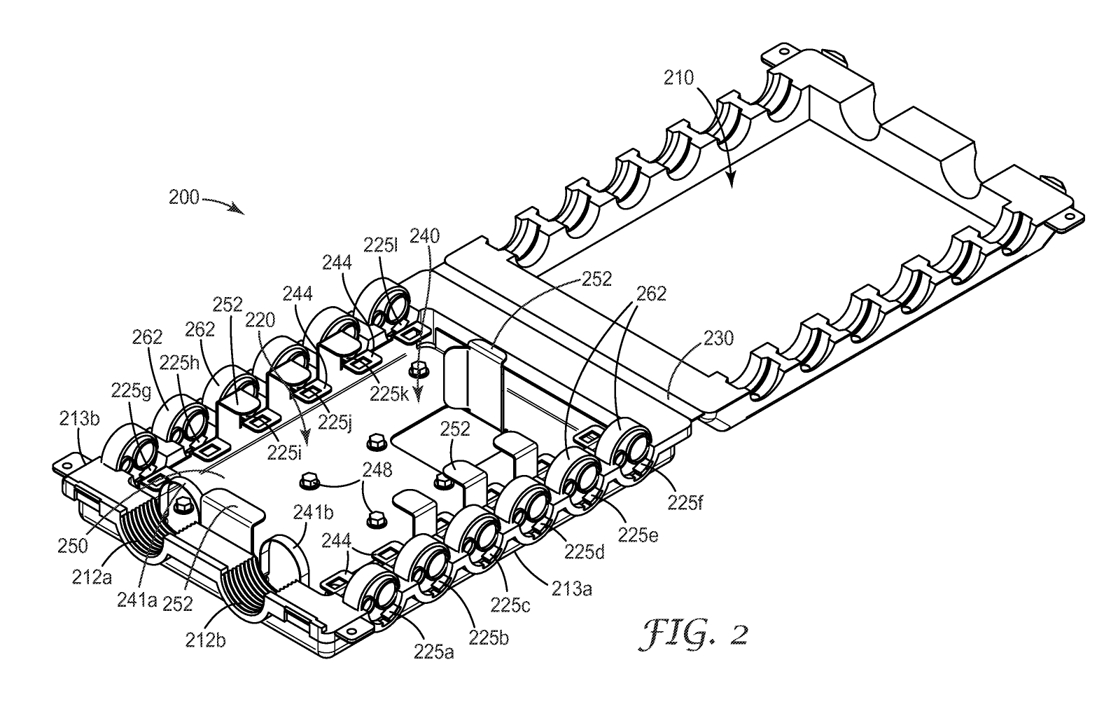

FIGS. 1A-1E show several different views of exemplary junction box 100. FIGS. 1A and 1B show junction box 100 in a closed position, whereas FIGS. 1C-1E show junction box 100 (or a portion thereof) in an open position. Junction box 100 includes a cover 110 and a base 120. An interior portion, or central cavity 140, is enclosed by the cover and base when junction box is placed in the closed position. Main communication cables can enter the junction box via ports 112a, 112b. The individual lines within the main cables can be separated within junction box 100 and distributed to different locations on the cell tower via multiple exit ports located on different sides of the junction box. In this example, exit ports 125a-125f are located on side 113b of junction box 100 and exit ports 125g-125l are located on side 113a of junction box 100.

The cover and the base 110, 120 are configured for engagement with each other and used, in a manner to be described below, to form a protective re-enterable enclosure. While junction box 100 is shown as having a generally rectangular construction, the junction box may assume other shapes or configurations as are required for a particular application.

In a preferred aspect, junction box 100 has a relatively compact structure, with a length of about 12 to about 24 inches, a width of about 12 to about 17 inches, and a cavity depth of about 3 to about 5 inches.

In one aspect, base 120 and the cover 110 are integrally molded with each other and joined at a region of reduced thickness that defines a hinge 130 disposed on a rear end of the junction box. This type of hinge is known and is often referred to as a “living” hinge. In another aspect, base 120 and cover 110 can be separately formed members that are movably joined to each other at hinge 130. The base and cover can be configured for a snap fit engagement at front end 111, where tabs 118a and 118b can be provided for engagement/disengagement by the application of a moderate hand force. In addition, securing clips 117a and 117b, formed on respective sides 113a and 113b of junction box 100 can be used to further secure or lock the junction box in a closed position, by e.g., use of a conventional fastener or padlock. In an alternative aspect, a latch mechanism can be used to secure junction box 100 in a closed position.

In one embodiment, junction box 100 (i.e., cover 110, base 120) is formed from a suitable plastic material, for example polyethylene or polyamide. Cover 110 and base 120 may be formed from the same material, or from different materials, depending upon the desired or required material properties. Cover 110 and base 120 may be formed using any suitable manufacturing technique, such as injection molding or blow molding. In a preferred aspect, junction box 100 is manufactured as a double wall blow molded structure, which allows the outer surfaces of the junction box 100 to remain smooth.

The junction box is configured to receive conventional cell tower cabling via ports 112a and 112b formed at front end 111. In one aspect, ports 112a, 112b are configured as through-holes or bores formed in portions of the front ends of the base and the cover. Alternatively, the ports 112a, 112b can be bores formed entirely in the front end portion of the base or of the cover, depending on the particular portion. For example, coaxial cables are used to transmit radio frequency signals from the amplifiers at the base of cell phone towers to the antennae on the top of the tower. Some coaxial cables have up to about a 2″ diameter for most of the distance between the amplifiers and the antennae. The large diameter can provide better signal to noise performance than with smaller diameter cables. In addition, smaller diameter ‘flex’ cables can be employed, with better flexibility but higher loss, at the top of the towers for the final connection to the antennae. In addition, hybrid cables that include an optical fiber (or multiple optical fibers) in combination with a coaxial cable can be utilized.

Optionally, corrugated tubing 115a, 115b can be utilized in ports 112a, 112b to accommodate the main communication cabling (not shown) that enters junction box 100. The tubing can provide a snug fit around multiple pair cabling that enters the junction box. The tubing 115a, 115b can be retained within junction box 100 via clamps 141a, 141b (see FIGS. 1C and 1D) disposed in the central cavity 140 of the junction box. This clamping allows the main communication cabling to be secured within box 100 while the box is placed in an open position. In one aspect, each main cable includes three cable pairs, where each cable pair includes a copper wire and a fiber line (which may include one or more optical fibers).

As mentioned above, cover 110 and base 120 form a central cavity 140. Included in the central cavity are one or more plates (in this example, plates 142a, 142b) that are securely disposed on an inner surface of either cover 110 or base 120 (in this example, plates 142a, 142b are formed on an inner surface of base 120). The one or more plates may be formed from a rigid material, such as a metal. Plates 142a, 142b provide support for clamps 141a, 141b and for multiple strain relief brackets or ties 144. The multiple strain relief brackets 144 (in this example, six individual strain relief brackets are shown, although a greater or fewer number can be utilized) are configured to engage or clamp individual wires (not shown) from the main cabling to the support plates 142a, 142b. In this manner, the individual wires can be distributed to different locations on the cell tower while being physically secured at a location other than the base.

In addition, in this exemplary aspect, through-holes 148a and 148b disposed in plates 142a, 142b can be utilized to secure junction box 100 to the strut or frame (not shown) of the cell tower/antenna structure. Conventional bolts or other fasteners can be utilized. In an alternative aspect, the one or more support plates may extend through a wall(s) of the junction box so that the junction box can be secured to the strut or frame (not shown) of the cell tower/antenna structure while having box 100 maintained in a closed position.

The interior cavity 140 further includes one or more cable routing members 146 formed on an inner surface of either cover 110 or base 120 (in this example, cable routing member 146 is formed on an inner surface of base 120). The one or more cable routing members 146 provide support structures to route excess cables or lines to provide slack storage within junction box 100.

In order to distribute individual lines to various locations at the cell tower antenna location, junction box 100 includes multiple output ports. In this example, a first set of output ports 125a-125f are provided on a first side 113b of junction box 100 and a second set of output ports 125g-125l are provided on a second side 113a of junction box 100. While six ports are provided on opposing sides of junction box 100 in this example, in alternative aspects, a greater or fewer number of output ports can be provided, as would be apparent to one of ordinary skill in the art given the present description. In a preferred aspect, each of the ports can be sized to have a standard opening, such as about a 2 inch diameter opening, to receive a conventional end cap (not shown) that can accommodate cables or lines of different sizes to provide some retention. Cables and/or lines of different sizes can be inserted through the same sized end caps. Exemplary end caps are fully described in U.S. Pat. No. 4,822,954, incorporated by reference in its entirety.

Thus, in operation, a main cable can enter junction box 100 via entry port 112a or 112b. The individual lines within the main cable can be routed to either one or more of exit ports 125a-125f or exit ports 125g-125l and out to different locations on a cell tower antenna. In addition, with the junction box design described herein, an installer can separate the required antenna wiring/lines and secure them within the junction box either at the cell tower base or at a location near the top of the cell tower.

Optionally, junction box 100 can be configured to include a groove or other structure that receives a sealing gasket or the like, although it is not required that junction box 100 provides a hermetic seal.

Another exemplary junction box 200 is shown in FIG. 2. Junction box 200 includes a cover 210 and a base 220. An interior portion, or central cavity 240, is enclosed by the cover and base when junction box is placed in a closed position. Main communication cables can enter the junction box via ports 212a, 212b. The individual lines within the main cables can be separated within junction box 200 and distributed to different locations on the cell tower via multiple exit ports located on different sides of the junction box. In this example, exit ports 225a-225f are located on side 213a of junction box 200 and exit ports 225g-225l are located on side 213b of junction box 200.

The cover and the base 210, 220 are configured for engagement with each other and used to form a protective re-enterable enclosure, such as described above. While junction box 200 is shown as having a generally rectangular construction, the junction box may assume other shapes or configurations as are required for a particular application.

In a preferred aspect, junction box 200 has a relatively compact structure, with a length of about 12 to about 24 inches, a width of about 12 to about 17 inches, and a cavity depth of about 3 to about 5 inches.

In one aspect, base 220 and the cover 210 are integrally molded with each other and joined at a region of reduced thickness that defines a hinge 230 disposed on a rear end of the junction box. This type of hinge can be a living hinge. In another aspect, base 220 and cover 210 can be separately formed members that are movably joined to each other at hinge 230. The base and cover can be configured for a snap fit engagement or a latch mechanism can be used to secure junction box 200 in a closed position.

In one embodiment, junction box 200 (i.e., cover 210, base 220) is formed from a suitable plastic material, for example polyethylene or polyamide. Cover 210 and base 220 may be formed using any suitable manufacturing technique, such as injection molding or blow molding.

The junction box is configured to receive conventional cell tower cabling via ports 212a and 212b that can be configured as through-holes or bores formed in portions of the front ends of the base and the cover. Alternatively, the ports 212a, 212b can be bores formed entirely in the front end portion of the base or of the cover, depending on the particular portion. The cables received by junction box 200 can be similar to those described above.

Optionally, corrugated tubing (not shown in FIG. 2) can be utilized in ports 212a, 212b to accommodate the main communication cabling (not shown) that enters junction box 200. The tubing can provide a snug fit around multiple pair cabling that enters the junction box. The tubing can be retained within junction box 200 via clamps 241a, 241b disposed in the central cavity 240 of the junction box. This clamping allows the main communication cabling to be secured within box 200 while the box is placed in an open position. In one aspect, each main cable includes three cable pairs, where each cable pair includes a copper wire and a fiber line (which may include one or more optical fibers).

As mentioned above, cover 210 and base 220 form a central cavity 240. In this aspect of the present invention, the central cavity can accommodate a removable plate, such as plate 250, that can be configured to fit within the entire central cavity, or at least a portion thereof. Plate 250 can be formed from a suitable material, such as steel or aluminum, and can be customized with cable management features for one or more particular applications, such as the distribution and management of loose wire or conduit. In this aspect, junction box 200 can be configured to accommodate several different cable management plates so that it can be utilized in different cable management applications.

In this alternative aspect, plate 250 includes a plurality of cable storage and cable routing structures, such as tabs 252, that are disposed at various portions of the central cavity 240, for routing and retaining cables within box 200 and to provide slack storage.

In addition, a series of cable supports 244 can be formed on plate 250, where each cable support 244 provides a support structure for a cable tie or other device used to secure the position of a wire exiting the junction box 200 at a particular exit port. In addition, plate 250 can further accommodate one or more cable clamps (not shown) to further secure the individual wires from the main cabling within the junction box. In addition, one or more conventional bolts 248 can be utilized to secure junction box 200 to the strut or frame (not shown) of the cell tower/antenna structure. In an alternative aspect, the plate 250 can be configured to extend through a wall(s) of the junction box so that the junction box can be secured to the strut or frame (not shown) of the cell tower/antenna structure while having box 200 maintained in a closed position.

In order to distribute individual lines to various locations at the cell tower antenna location, junction box 200 includes multiple output ports. In this example, a first set of output ports 225a-225f are provided on a first side 213a of junction box 200 and a second set of output ports 225g-225l are provided on a second side 213b of junction box 200. While six ports are provided on opposing sides of junction box 200 in this example, in alternative aspects, a greater or fewer number of output ports can be provided. For example, in another aspect, junction box 200 can be of even more compact size, with two exit ports formed on each side of the box. In a preferred aspect, each of the ports can be sized to have a standard opening, such as about a 2 inch diameter opening, to receive a conventional end cap, such as end caps 262, that can accommodate cables or lines of different sizes to provide some retention. Such exemplary end caps are fully described in U.S. Pat. No. 4,822,954, incorporated by reference in its entirety.

Thus, in operation, a main cable can enter junction box 200 via entry port 212a or 212b. The individual lines within the main cable can be routed to either one or more of exit ports 225a-225f or exit ports 225g-225l and out to different locations on a cell tower antenna. In addition, with the junction box design described herein, an installer can separate the required antenna wiring/lines and secure them within the junction box either at the cell tower base or at a location near the top of the cell tower.

The junction box embodiments described herein provide an enclosure that protects and secures the transition of cell tower cabling. The junction box provides strain relief, slack storage and protection for the individual cables. The junction box as described herein is of straightforward construction, and uses comparatively few components to enable easy assembly in the field, even at difficult or inaccessible locations.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An enclosure for protecting transitioning cell tower cables, comprising:
a base; and
a cover coupled to the base via a hinge, the base and the cover forming an interior cavity when placed in a closed position, wherein the enclosure further includes at least one entrance port formed in at least a portion of a front end of at least one of the base and the cover, and wherein the enclosure further includes a plurality of exit ports, wherein a first set of exit ports are formed in a first side wall of the enclosure and a second set of exit ports are formed in a second side wall of the enclosure, the at least one entrance port configured to receive a first cable comprising multiple lines, and wherein the plurality of exit ports are each configured to receive at least one individual line from the multiple lines.

2. The enclosure of claim 1, wherein one or more support plates are disposed in the interior cavity, wherein a plurality of strain relief brackets are mounted to the one or more support plates and are configured to clamp individual lines from the first cable to the one or more support plates.

3. The enclosure of claim 1, wherein each exit port includes an end cap configured to receive at least one of the individual lines.

4. The enclosure of claim 1, wherein the first and second side walls are opposite one another.

5. The enclosure of claim 1, further comprising corrugated tubing received in the at least one entrance port, the corrugated tubing configured to accommodate the first cable.

6. The enclosure of claim 5, further comprising a cable clamp to clamp the first cable and corrugated tubing to a first support plate of the one or more support plates.

7. The enclosure of claim 1, further comprising through-holes disposed in the one or more support plates to receive fasteners to secure the enclosure to a strut or frame of the cell tower.

8. The enclosure of claim 2, wherein at least one of the one or more support plates extends outside the enclosure.

9. The enclosure of claim 8, further comprising through-holes disposed in the one or more support plates outside the enclosure to receive fasteners to secure the enclosure to a strut or frame of the cell tower.

10. The enclosure of claim 1, further comprising one or more cable routing members formed on an inner surface of at least one of the cover and the base.

11. The enclosure of claim 1, wherein the enclosure comprises a double wall blow molded structure.

12. The enclosure of claim 1, wherein the enclosure has a length of about 18 to about 24 inches, a width of about 14 to about 17 inches, and a cavity depth of about 3 to about 5 inches.

13. The enclosure of claim 1, wherein the hinge comprises a living hinge.

14. The enclosure of claim 1, further comprising a cable management plate disposed in the interior cavity, the cable management plate having a plurality of cable routing structures for routing and retaining cables within the enclosure.
